(19) United States
(12) Patent Application Publication
(10) Pub. No.: US 2001/0053973 A1
(43) Pub. Date: Dec. 20, 2001

(54) Bit allocation apparatus and method

(75) Inventor: Takeshi Tsuzuki, Shinagawa (JP)

Correspondence Address: ARENT FOX KINTNER, PLOTKIN & KAHN, PLLC, Suite 600, 1050 Connectict Avenue, N.W., Washington, DC, 20036-5339, US

(73) Assignee: FUJITSU LIMITED

(21) Appl. No.: 09/784,183

(22) Filed: Feb. 16, 2001

(30) Foreign Application Priority Data
Jun. 20, 2000 (JP) 2000-184862

(51) Int. Cl. G10L 19/02

(52) U.S. Cl. 704/229

(57) ABSTRACT

A bit allocation processing section allocates quantization bits to each subband on the basis of the information of each SMR input from a psychoacoustic model processing section by using a bit allocation table that associates the sound information amount (SMR) of each audible sound with a bit allocation count, thereby allocating the quantization bits indicated by the bit allocation table to each subband. By performing this processing once for each subband, bits can be allocated to each subband. This makes it possible to eliminate the necessity to perform a loop process and shorten the arithmetic processing time required for bit allocation processing.

### CROSS-REFERENCE TO RELATED APPLICATIONS

This application is based upon and claims priority of Japanese Patent Application No. 2000-184862, filed on Jun. 20, 2000, the contents being incorporated herein by reference.

### BACKGROUND OF THE INVENTION

1. Field of the Invention

The present invention relates to bit allocation apparatus and methods, in particular, suitably used for quantization bit allocation processing in MPEG (Moving Picture Experts Group) audio encoding.

2. Description of the Related Art

Conventionally, in bit allocation processing in MPEG audio encoding, an audio signal supplied as a time-base signal is decomposed into signals in an arbitrary frequency band, called “subbands”, by a subband filtering device. A human audible sound information amount called “SMR (Signal-to-Mask Ratio)” is then obtained in units of subbands by using human psychoacoustic characteristics.

Furthermore, an MNR (Mask-to-Noise Ratio), which is the ratio of a masking threshold to noise based on an error value accompanying quantization for each subband is obtained by subtracting each SMR obtained as above from an SNR (Signal-to-Noise Ratio) representing average image quality as a reference for bit allocation. The masking threshold is the minimum magnitude of an audio signal that cannot be identified by the human ear. According to the MPEG audio principle, quantization bits are adaptively allocated to signal components in the audible range without allocating any quantization bits to audio signals that cannot be identified, thereby attaining data amount compression.

The MNR obtained in the above manner is an index indicating the degree to which the human ear can hear an error signal (degree of noise), and hence the number of allocation bits based on a predetermined bit rate are sequentially allocated bit by bit to subbands in increasing order of MNR values. Bit allocation processing is repeated until all allocation bits are allocated or no allocation bit can be allocated any more, thereby adaptively allocating quantization bits to the respective subbands.

FIG. 13 is a flowchart showing the flow of this bit allocation processing. Referring to FIG. 13, in step S11, an MNR representing the degree of noise is calculated (MNR=SNR−SMR) for each subband. In step S12, the respective subbands, whose MNRs were obtained in step S11, are searched for a subband whose MNR is the minimum value. The subband having the minimum MNR indicates the maximum information amount.

In step S13, the current number of bits allocated is calculated. In step S14, the number of bits calculated in step S13 is allocated to the subband searched out in step S12. In step S15, an MNR is calculated again. Thereafter, it is checked in step S16 whether the bit allocation processing is terminated. If it is determined that no bit can be allocated to each subband any more, the processing is terminated. If it is determined that bits can be allocated, the flow returns to step S12 to continue the bit allocation processing.

In step S15, the MNR of the subband to which bits were allocated in step S14 is increased to a predetermined level. If the flow returns to step S12 without performing this processing, the same subband is searched out as a subband having the minimum MNR. As a consequence, the same subband is always selected, and bits are allocated to it. In the processing in step S15, therefore, the MNR of the subband to which bits were allocated is raised to increase the chance of allocating bits to other subbands.

In the conventional bit allocation method, when overall allocation bits determined by a bit rate are to be allocated to each subband, bits are allocated to one subband little by little in one loop process in FIG. 13. For this reason, the loop process shown in FIG. 13 must be repeated many times until the end of bit allocation processing for each subband. In addition, since the operations in steps S12 and S13 themselves to be performed in this loop process are executed by the loop process, the arithmetic processing time required for bit allocation is greatly prolonged.

In recent MPEG audio encoding, this arithmetic processing is complicated, including bit allocation processing. Since encoding must be done in real time, an increase in the speed of arithmetic processing for encoding is required. An increase in the operation speed of an encoding apparatus can be attained to a certain extent by using a processor with a high throughput. This scheme has its own limit and demands a very high cost. To perform complicated arithmetic processing in a short period of time at a low cost, therefore, arithmetic processing for encoding must be optimized.

### SUMMARY OF THE INVENTION

It is an object of the present invention to shorten greatly the arithmetic processing time required for MPEG audio encoding by greatly shortening the processing time taken for bit allocation without using any high-performance processor.

In bit allocation apparatus and method according to the present invention, quantization bits are allocated to each subband on the basis of the information of the sound information amount of each input audible sound by using a bit allocation table that associates the sound information amount (SMR) of each audible sound with a bit allocation count.

Bit allocation for each subband can be performed by performing the following processing once for each subband: looking up the bit allocation table on the basis of the SMR value of each subband and allocating the quantization bits indicated by the bit allocation table to each subband. This eliminates the necessity to perform many loop processes as in the conventional bit allocation method.

### BRIEF DESCRIPTION OF THE DRAWINGS

FIG. 1 is a block diagram showing an example of construction of the main part of an MPEG audio encoding apparatus including a bit allocation apparatus according to an embodiment of the present invention;

FIG. 2 is a flowchart showing an example of operation of a bit allocation processing section according to the embodiment;

FIG. 3 is a representation for explaining the principle of bit allocation processing according to the embodiment;

FIG. 4 is a flowchart showing another example of operation of the bit allocation processing section according to the embodiment;

FIG. 5 is a representation showing various bit allocation tables;

FIGS. 6 to 12 each are a representation showing a bit allocation table or the like; and

FIG. 13 is a flowchart showing conventional bit allocation processing.

### DETAILED DESCRIPTION OF THE PREFERRED EMBODIMENTS

An embodiment of the present invention will be described below with reference to drawings.

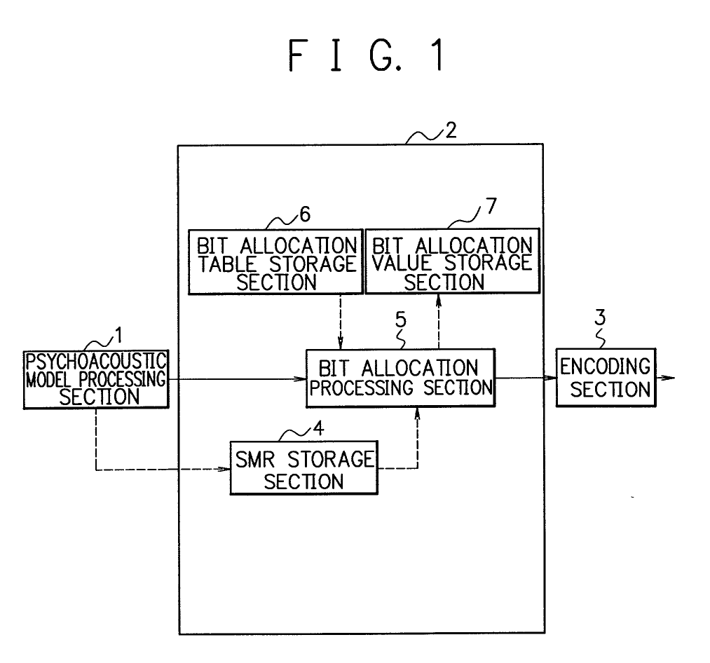

FIG. 1 is a block diagram showing an example of construction of the main part of an MPEG audio encoding apparatus including a bit allocation apparatus according to an embodiment of the present invention. Referring to FIG. 1, solid arrows indicate the flow of processing, and broken arrows indicate the flow of data.

Referring to FIG. 1, a psychoacoustic model processing section 1 is for masking those signals of the respective subband signals formed by decomposing a time-axis audio signal into audio signals in a frequency band which have specific frequency components which the human ear cannot hear on the basis of the human psychoacoustic characteristics. With this operation, the above SMR, which is the human audible sound information amount of each subband, is obtained for each subband.

A bit allocation apparatus 2 is for adaptively allocating, to each subband, a predetermined number of allocation bits determined in accordance with a bit rate by using each SMR obtained by the psychoacoustic model processing section 1. An encoding section 3 is for performing MPEG audio encoding processing including quantization in accordance with the number of quantization bits allocated to the respective subbands by the bit allocation apparatus 2, thereby compressing data.

The bit allocation apparatus 2 described above includes an SMR storage section 4, a bit allocation processing section 5, a bit allocation table storage section 6, and a bit allocation value storage section 7. The SMR storage section 4 stores the SMRs obtained in units of subbands by the psychoacoustic model processing section 1. The bit allocation processing section 5 allocates quantization bits to the respective subbands by looking up the bit allocation table stored in the bit allocation table storage section 6 on the basis of the SMRs of the subbands stored in the SMR storage section 4.

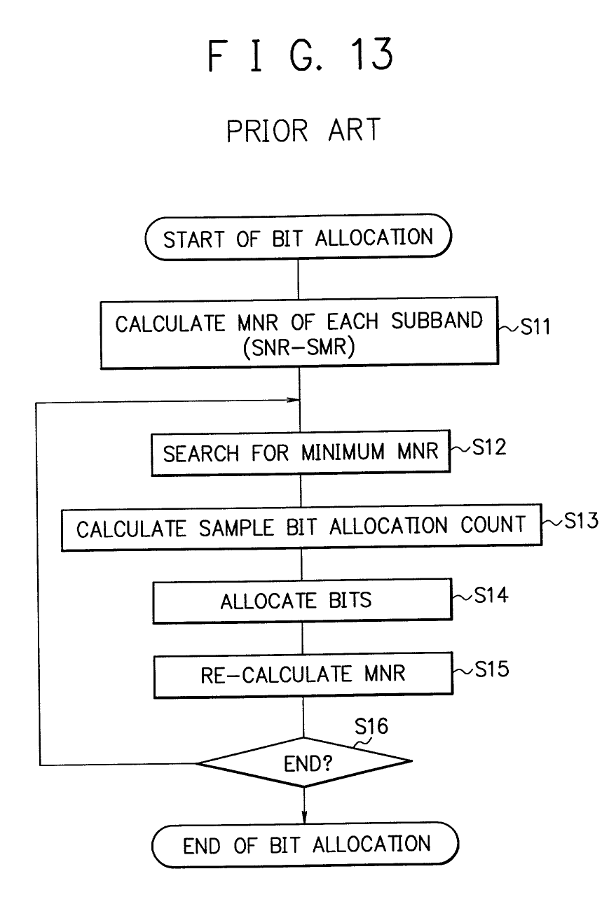

The bit allocation table described above is a lookup table indicating how many bits should be allocated to subbands in accordance with the values of the corresponding SMRs. The bit allocation processing section 5 looks up this bit allocation table to allocate quantization bits to each subband in accordance with the value of the SMR of each subband, and hence can allocate quantization bits to one subband by looking up the table once. This eliminates the necessity to perform a loop process as in FIG. 13.

The bit allocation value storage section 7 stores the quantization bit values of the respective subbands which are allocated by the bit allocation processing section 5. The encoding section 3 encodes in accordance with the bit allocation values for the respective subbands stored in the bit allocation value storage section 7.

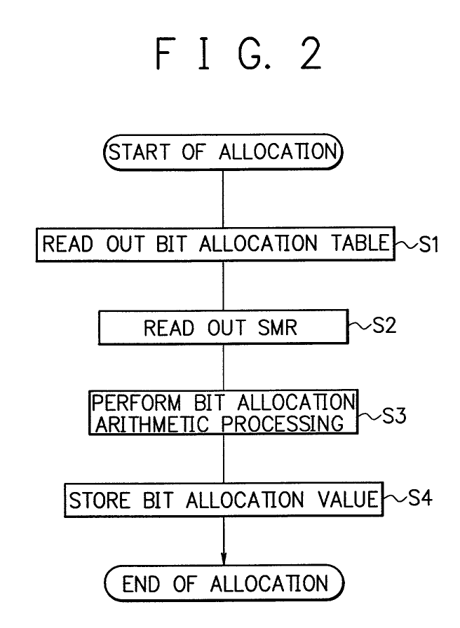

FIG. 2 is a flowchart showing an operation of the bit allocation processing section 5. Referring to FIG. 2, in step S1, the section 5 reads out the bit allocation table stored in the bit allocation table storage section 6 in advance. In step S2, the bit allocation processing section 5 reads out the SMRs stored in the SMR storage section 4. In step S3, the section 5 obtains quantization bits allocated to the respective subbands on the basis of the read bit allocation table and SMRs. In step S4, the section 5 stores the obtained bit allocation values in the bit allocation value storage section 7.

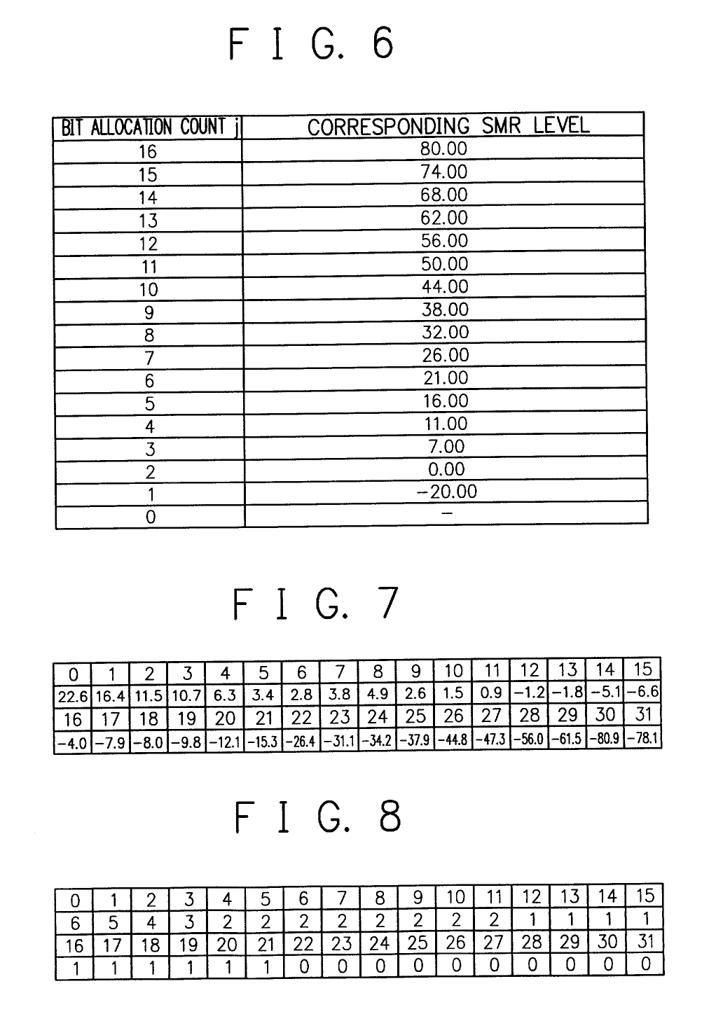

FIG. 6 shows an example of bit allocation table. As shown in FIG. 6, the bit allocation table in this embodiment is formed by a lookup table representing the relationship between bit allocation counts j of 0 to 16 and the levels (unit: [dB]) of SMRs corresponding to the respective bit allocation counts

According to the bit allocation table shown in FIG. 6, if, for example, the SMR value of a subband is (80≦SMR), 16 bits are allocated to the subband. If the SMR value is (74≦SMR<80), 15 bits are allocated to the subband. Likewise, if the SMR value of a subband is (SMR<−20), 0 bit is allocated to the subband.

That is, as the SMR value of a subband increases, more quantization bits are allocated to the subband, and vice versa. A range in which the SMR value is small is a range in which the human ear has difficulty in hearing the sound. It is therefore useless to allocate many quantization bits to this range. In contrast to this, many quantization bits are allocated to a range in which the SMR value is large and the sound level is high, thereby expressing even slight differences between sounds. This bit allocation table is, for example, empirically created on the basis of the result obtained by actually performing bit allocation processing using a conventional bit allocation technique.

FIG. 7 is a representation showing an example of SMR of each subband stored in the SMR storage section 4. Referring to FIG. 7, the numbers 0 to 31 in the first and third rows represent subband numbers, and the numerical values in the second and fourth rows represent SMR values.

FIG. 8 shows the result obtained by allocating quantization bits to the respective subbands by using the bit allocation table in FIG. 6 on the basis of the SMRs in FIG. 7. Referring to FIG. 8, the numbers 0 to 31 in the first and third rows represent subband numbers, and the numerical values in the second and fourth rows represent bit allocation values (quantization bit counts).

Referring to FIG. 8, for subband 0, the bit allocation value is set to “6” in accordance with the SMR value “22.6”. For subband 1, the bit allocation value is set to “5” in accordance with the SMR value “16.4”. Likewise, for subband 31, the bit allocation value is set to “0” in accordance with the SMR value “−78.1”.

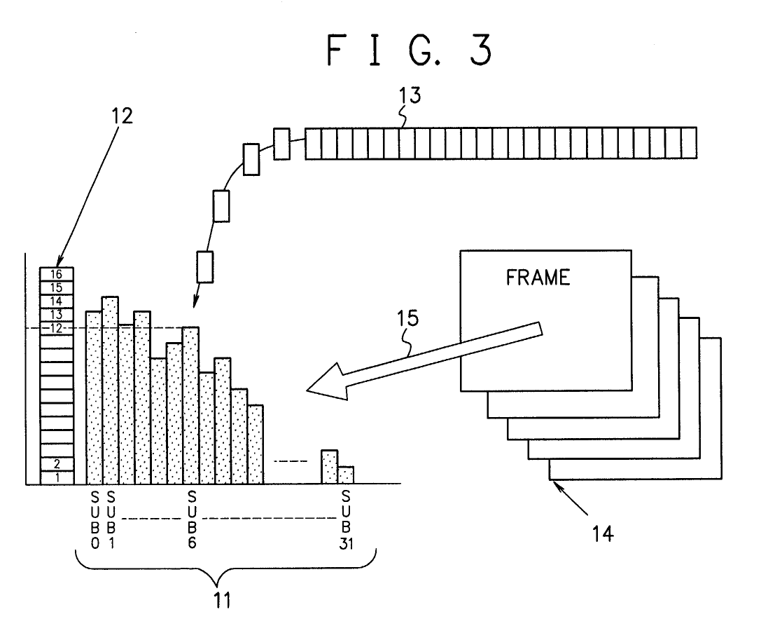

FIG. 3 is a representation for explaining the principle of bit allocation processing according to this embodiment. As shown in FIG. 3, audio data 14 to be compressed has frames per unit time (e.g., one second). The number of allocation bits 13 per unit time is determined in accordance with the bit rate of the audio data 14. The overall allocation bits 13 are divisionally allocated to each frame of the audio data 14.

Each frame of the audio data 14 is decomposed into subbands, and a psychoacoustic model process 15 is performed for the subbands to obtain SMRs 11 of the respective subbands. In the case shown in FIG. 3, the SMRs 11 of 32 subbands, i.e., subbands 0 to 31, are obtained in accordance with the table shown in FIG. 6. The values of the SMRs 11 of the respective subbands are expressed in a bar graph.

In this embodiment, quantization bits corresponding to the values of the SMRs 11 are allocated to the respective subbands by collating the values of the SMRs 11 of the respective subbands with a bit allocation table 12. The dashed line in FIG. 3 indicates a state wherein the quantization bit count “12” indicated by the bit allocation table 12 is allocated to subband 6 (SUB 6) by looking up the bit allocation table 12 on the basis of the value of the SMR 11.

As described above, in this embodiment, bit allocation for each subband can be performed by performing the following processing once for each subband: looking up the bit allocation table on the basis of the SMR value of each subband and allocating bits indicated by the bit allocation table to each subband. In the conventional bit allocation method, a loop process like the one in steps S12 to S16 in FIG. 13 must be repeated many times, and loop processes must be performed even in steps S12 and S13.

In contrast to this, according to this embodiment, there is no need to perform the loop processes in steps S12 and S13 and the loop process in steps S12 to S16, and quantization bits to be allocated to one subband can be obtained at once by only looking up the lookup table. Therefore, the processing time taken for bit allocation can be greatly shortened without using any high-performance processor, and hence the processing speed of MPEG audio encoding can be greatly increased.

Note that when bit allocation is performed by using one general bit allocation table in this manner, the bit allocation result based on the bit allocation table is not always optimal depending on the bit rate. More specifically, if the bit rate is low, since the overall allocation bit count is small, the total number of quantization bits allocated to the respective subbands on the basis of the table may exceed the overall allocation bit count. In contrast to this, if the bit rate is high, since the overall allocation bit count is large, the total number of quantization bits allocated to the respective subbands on the basis of the table may become greatly smaller than the overall allocation bit count. As a consequence, a large number of bits may be left unallocated.

The contents of the bit allocation table may be flexibly changed in accordance with an encoding condition such as a bit rate, or bit allocation tables having different contents may be prepared in advance to be selectively used in accordance with an encoding condition such as a bit rate.

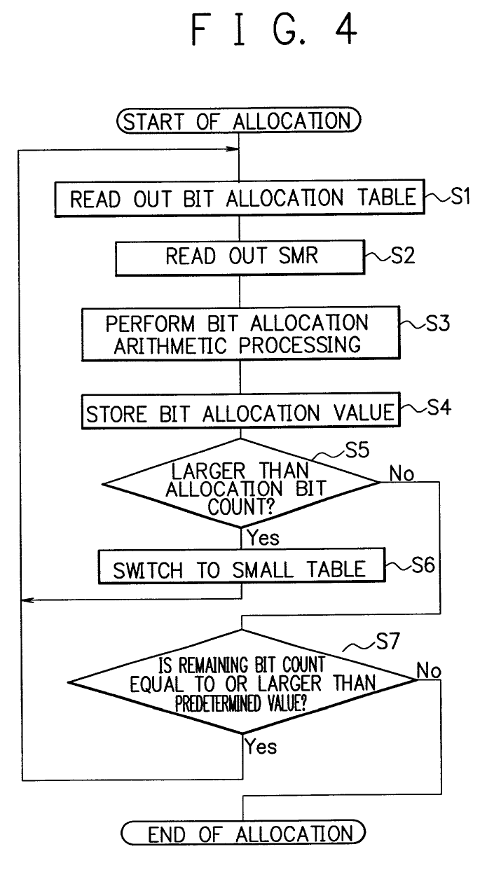

Alternatively, bit allocation tables having different contents may be prepared in advance, and bit allocation may be performed first by using a general bit allocation table. After this bit allocation, it is checked whether the total number of quantization bits allocated to the respective subbands on the basis of the general table exceeds the overall allocation bits, or the number of remaining bits is larger than a predetermined number. In accordance with this determination result, the general table is switched to a different bit allocation table, and bit allocation processing is performed again. The operation in this case will be described with reference to the flowchart of FIG. 4.

The processing in steps S1 to S4 in FIG. 4 is the same as that described with reference to FIG. 2. In the early stage of bit allocation processing, the processing in steps S1 to S4 is performed by using a general bit allocation table like the one shown in FIG. 6. In step S5, it is checked whether the total number of quantization bits allocated to the respective subbands on the basis of the general bit allocation table exceeds the overall allocation bit count.

If the actual bit allocation count exceeds the allocation bit count based on the bit rate, the flow advances to step S6 to switch to a bit allocation table which is set such that the total quantization bit allocation count is smaller than that with the general bit allocation table described above. The flow then returns to step S1 to perform similar processing by using this small bit allocation table.

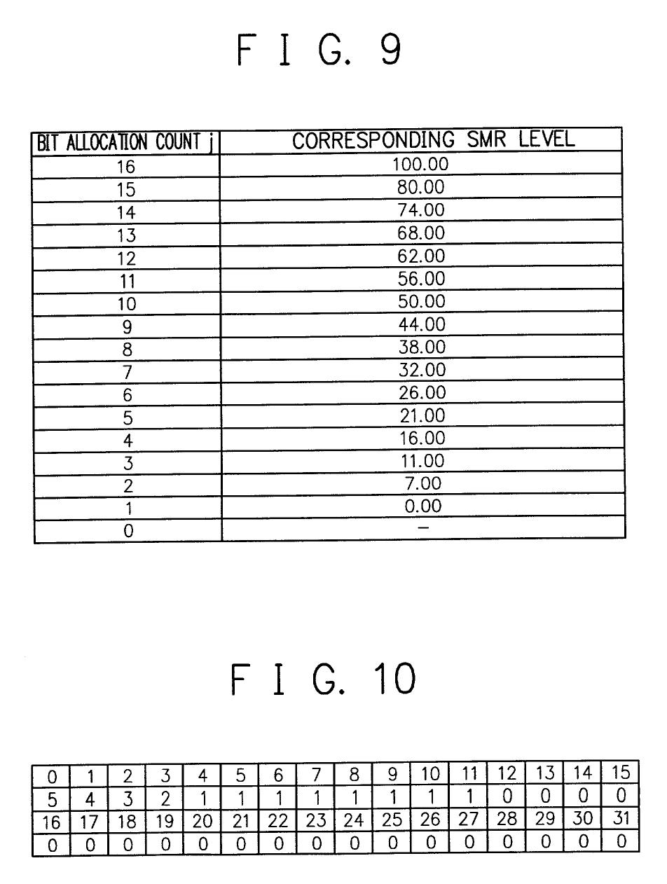

FIG. 9 shows an example of small bit allocation table which is set such that the total bit allocation count is smaller than that with the general bit allocation table. The bit allocation table shown in FIG. 9 is defined such that when, for example, the SMR value of a subband is (100≦SMR), 16 bits are allocated to the subband, and when the SMR value is (80≦SMR<100), 15 bits are allocated to the subband.

FIG. 10 shows the result obtained by allocating quantization bits to the respective subbands by using the bit allocation table in FIG. 9 on the basis of the SMRs in FIG. 7. Referring to FIG. 10, the numbers 0 to 31 in the first and second rows represent subband numbers, and the numerical values in the second and fourth rows represent bit allocation values (quantization bit counts).

Referring to FIG. 10, for example, for subband 0, the bit allocation value is set to “5” in accordance with the SMR value “22.6”. For subband 1, the bit allocation value is set to “4” in accordance with the SMR value “16.4”. As described above, by using the bit allocation table shown in FIG. 9, the total number of quantization bits allocated to the respective subbands becomes smaller than that with the general bit allocation table. Even if the bit rate is low, therefore, quantization bits can be adaptively allocated to the respective subbands in a range in which the total number of quantization bits allocated does not exceeds the allocation bit count determined by the bit rate.

If it is determined in step S5 that the actual bit allocation count does not exceed the allocation bit count based on the bit rate, the flow advances to step S7 to check as to whether or not the number of remaining bits that are not allocated to any of the subbands is larger than a predetermined number. If it is determined that the number of remaining bits exceeds the predetermined number, the flow advances to step S8 to switch to a bit allocation table which is set such that the total quantization bit allocation count is larger than that with the general bit allocation table. Thereafter, the flow returns to step S1 to perform similar processing by using the large bit allocation table.

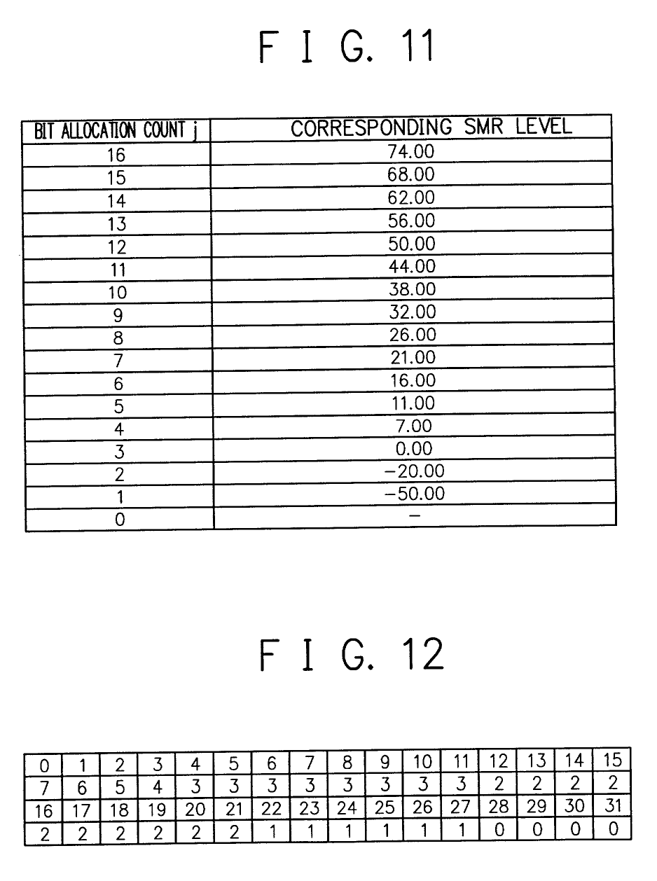

FIG. 11 shows an example of large bit allocation table which is set such that the total bit allocation count is larger than that with the general bit allocation table. The bit allocation table shown in FIG. 11 is defined such that when, for example, the SMR value of a subband is (74≦SMR), 16 bits are allocated to the subband, and when the SMR value is (68≦SMR<74), 15 bits are allocated to the subband.

FIG. 12 shows the result obtained by allocating quantization bits to the respective subbands by using the bit allocation table in FIG. 11 on the basis of the SMRs in FIG. 7. Referring to FIG. 12, the numbers 0 to 31 in the first and second rows represent subband numbers, and the numerical values in the second and fourth rows represent bit allocation values (quantization bit counts).

Referring to FIG. 12, for example, for subband 0, the bit allocation value is set to “7” in accordance with the SMR value “22.6”. For subband 1, the bit allocation value is set to “6” in accordance with the SMR value “16.4”. As described above, by using the bit allocation table shown in FIG. 11, the total number of quantization bits allocated to the respective subbands becomes smaller than that with the general bit allocation table. Even if the bit rate is high, therefore, quantization bits can be adaptively allocated to the respective subbands by sufficiently using the allocation bit count determined by the bit rate.

The case wherein a general bit allocation table like the one shown in FIG. 6 is used first has been described above. However, bit allocation tables to be used first may be adaptively switched depending on the set bit rate. More specifically, if the set bit rate is higher than a predetermined rate, the bit allocation table shown in FIG. 11 is used first, and then switched to the bit allocation tables shown in FIGS. 6 and 9, as needed, thus executing bit allocation processing. If the set bit rate is lower than the predetermined rate, the bit allocation table shown in FIG. 9 is used first, and then switched to the bit allocation tables shown in FIGS. 6 and 11, as needed, thus executing bit allocation processing.

In addition, the case wherein bit allocation processing is performed while the three bit allocation tables are adaptively switched has been described above. However, the number of bit allocation tables prepared is not limited to three. For example, if bit allocation processing is performed while four or more bit allocation tables are adaptively switched, quantization bits can be allocated to the respective subbands in a better state.

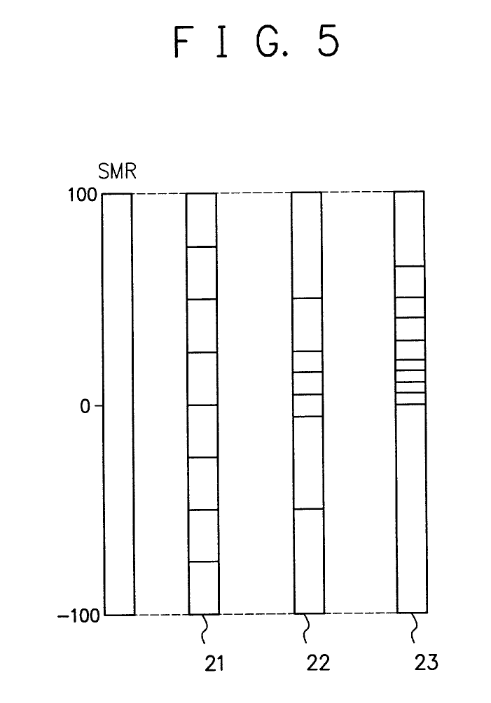

In the above embodiment, the range of possible SMR values is equally divided, and bit allocation counts of 0 to 16 are set, as shown in FIGS. 6, 9, and 11. However, the manner in which the range is divided is not limited to this, and the range may be divided arbitrarily. For example, a bit allocation table 21 in FIG. 5 exemplifies the table in which the range of SMR values given as −100 to 100 [dB] is equally divided, as in the tables shown in FIGS. 6, 9, and 11. In contrast to this, as in bit allocation tables 22 and 23 in FIG. 5, this range need not always be equally divided.

The bit allocation table 22 in FIG. 5 exemplifies the table in which the range of SMR values is divided into small ranges near 0 [dB], and divided into larger ranges as the SMR approaches −100 [dB] or 100 [dB]. This bit allocation table is then set such that larger numbers of quantization bits are allocated in decreasing order of sound level near 100 [dB].

The bit allocation table 23 in FIG. 5 exemplifies the table which is set such that quantization bits are allocated to subbands corresponding to sound levels equal to or higher than 0 [dB] while data corresponding to sound levels lower than 0 [dB] are completely masked with the bit allocation count being set to 0, and data in the range which corresponds to low sound levels near 0 [dB] is densely divided. Since the range lower than 0 [dB] is a range in which the human ear has difficulty in hearing, even if data in this range is discarded, no problem arises in terms of the sound quality of reproduced sounds.

As has been described above, according to this embodiment, quantization bits are allocated to the respective subbands in accordance with the sound information amounts of input audible sounds by using a bit allocation table that associates the sound information amounts (SMRs) of audible sounds with bit allocation counts. Therefore, bit allocation for each subband can be performed by performing the following processing once for each subband: looking up the bit allocation table on the basis of each SMR value and allocating quantization bits indicated by the bit allocation table to each subband. There is no need to perform a loop process as in FIG. 13. This makes it possible to shorten greatly the arithmetic processing time required for bit allocation processing regardless of the magnitude of a bit rate and increase the encoding speed of an MPEG audio encoding apparatus.

The embodiment described above should be considered as exemplary only in practicing the present invention. The technical range of the present invention should not be restrictively interpreted. That is, the present invention can be practiced in various forms without departing from the spirit and scope of the invention.

What is claimed is:

1. A bit allocation apparatus for adaptively allocating quantization bits to one or more subbands in encoding data, said apparatus comprising:
a table storage section storing a bit allocation table that associates the sound information amount of an audible sound with a bit allocation count; and
a bit allocation section for allocating quantization bits to said one or more subbands on the basis of said sound information amount of said audible sound being input and said bit allocation table stored in said table storage section.

2. The apparatus according to claim 1, wherein said sound information amount of said audible sound is an SMR.

3. The apparatus according to claim 1, wherein said table storage section stores bit allocation tables having different contents, and
said bit allocation section allocates quantization bits to said one or more subbands by selectively using one of said bit allocation tables in accordance with an encoding condition.

4. The apparatus according to claim 1, wherein said table storage section stores bit allocation tables having different contents, and
said bit allocation section allocates quantization bits to said one or more subbands by using said bit allocation tables with adaptively switching them.

5. The apparatus according to claim 4, wherein said bit allocation section selects a bit allocation table to be used first out of said bit allocation tables in accordance with an encoding condition.

6. The apparatus according to claim 1, wherein said table storage section stores bit allocation tables having different contents, and
said bit allocation section allocates quantization bits to said one or more subbands by using a first bit allocation table selected out of said bit allocation tables, changes said first bit allocation table to a second bit allocation table in accordance with the total number of quantization bits allocated to each subband, and re-allocates quantization bits to each subband.

7. The apparatus according to claim 6, wherein said bit allocation section allocates quantization bits by using said second bit allocation table which has been set such that the total number of quantization bits allocated is smaller than that with said first bit allocation table when the total number of quantization bits allocated by using said first bit allocation table is larger than a predetermined value.

8. The apparatus according to claim 6, wherein said bit allocation section allocates quantization bits by using said second bit allocation table which has been set such that the total number of quantization bits allocated is larger than that with said first bit allocation table when the total number of quantization bits allocated by using said first bit allocation table is smaller than a predetermined value.

9. The apparatus according to claim 6, wherein said bit allocation section allocates quantization bits by using said second bit allocation table which has been set such that the total number of quantization bits allocated is smaller than that with said first bit allocation table when the total number of quantization bits allocated by using said first bit allocation table is larger than a predetermined value, and allocates quantization bits by using said second bit allocation table which has been set such that the total number of quantization bits allocated is larger than that with said first bit allocation table when the total number of quantization bits allocated by using said first bit allocation table is smaller than said predetermined value.

10. The apparatus according to claim 2, wherein said bit allocation table has bit allocation counts set by equally dividing the range of said SMR.

11. The apparatus according to claim 2, wherein said bit allocation table has bit allocation counts set by unequally dividing the range of said SMR.

12. A bit allocation method of adaptively allocating quantization bits to one or more subbands in encoding data,
wherein a bit allocation table that associates the sound information amount of an audible sound with a bit allocation count is used to allocate quantization bits to said one or more subbands on the basis of said sound information amount of said audible sound being input.

13. The method according to claim 12, wherein said sound information amount of said audible sound is an SMR.

14. The method according to claim 12, wherein bit allocation tables having different contents are prepared and quantization bits are allocated to said one or more subbands by selectively using one of said bit allocation tables in accordance with an encoding condition.

15. The method according to claim 12, wherein bit allocation tables having different contents are prepared and quantization bits are allocated to said one or more subbands by using said bit allocation tables with adaptively switching them.

16. The method according to claim 15, wherein a bit allocation table to be used first is selected out of said bit allocation tables in accordance with an encoding condition.

17. The method according to claim 12, wherein bit allocation tables having different contents are prepared, quantization bits are allocated to said one or more subbands by using a first bit allocation table selected out of said bit allocation tables, said first bit allocation table is changed to a second bit allocation table in accordance with the total number of quantization bits allocated to each subband, and quantization bits are re-allocated to each subband.

18. The method according to claim 17, wherein quantization bits are allocated by using said second bit allocation table which has been set such that the total number of quantization bits allocated is smaller than that with said first bit allocation table when the total number of quantization bits allocated by using said first bit allocation table is larger than a predetermined value.

19. The method according to claim 17, wherein quantization bits are allocated by using said second bit allocation table which has been set such that the total number of quantization bits allocated is larger than that with said first bit allocation table when the total number of quantization bits allocated by using said first bit allocation table is smaller than a predetermined value.

20. The method according to claim 17, wherein quantization bits are allocated by using said second bit allocation table which has been set such that the total number of quantization bits allocated is smaller than that with said first bit allocation table when the total number of quantization bits allocated by using said first bit allocation table is larger than a predetermined value, and by using said second bit allocation table which has been set such that the total number of quantization bits allocated is larger than that with said first bit allocation table when the total number of quantization bits allocated by using said first bit allocation table is smaller than said predetermined value.

21. The method according to claim 13, wherein said bit allocation table has bit allocation counts set by equally dividing the range of said SMR.

22. The method according to claim 13, wherein said bit allocation table has bit allocation counts set by unequally dividing the range of said SMR.
